(19) United States
(12) Patent Application Publication
(10) Pub. No.: US 2025/0098697 A1
(43) Pub. Date: Mar. 27, 2025

(54) PROCESS TO BIND NUTRIENTS OR MINERALS TO COFFEE

(71) Applicant: ELECTROBREW INC, Peoria, IL (US)

(72) Inventor: Timothy Anders, Peoria, IL (US)

(21) Appl. No.: 18/729,111

(22) PCT Filed: Jan. 13, 2023
(86) PCT No.: PCT/US2023/010814

§ 371 Date: Jul. 15, 2024

Related U.S. Application Data
(60) Provisional application No. 63/299,263, filed on Jan. 13, 2022.

(51) Int. Cl. A23F 5/46

(52) U.S. Cl. CPC A23F 5/465

(57) ABSTRACT

The present invention comprises a process to bind electrolytes to ground or whole bean coffee. Amino acid electrolyte salts are destabilized resulting in an adhesive coating that is bound to the ground or whole bean coffee and results in a brew having increased electrolytes to counteract the diuretic properties of coffee.

### CROSS-REFERENCE TO RELATED APPLICATIONS

This application claims priority from U.S. Provisional Patent Application Ser. No. 63/299,263 filed Jan. 13, 2022 all of which is incorporated by reference in its entirety herein.

### BACKGROUND OF THE INVENTION

The present invention generally relates to the field enhancing coffee grounds and beans with supplemental compounds. More particularly, the invention relates to methods of adhering and/or binding dry powdered ingredients together to prevent separation of compounds.

Coffee alone can cause electrolyte imbalances as it causes losses in sodium, potassium, magnesium, calcium, and as a result can reduce the degree of hydration coffee can provide. Binding these elements to coffee may help prevent the effects of coffee being a diuretic.

Previous attempts to bind these elements to coffee beans or coffee grounds resulted in brewed coffee that lacks consistency in taste, texture, or viscosity. Solutions that are pure mixtures tend to leave supplement residue at the top or bottom of a bag or container of ground or whole bean coffee and do not evenly integrate and distribute throughout bag or container. In these situations, the added elements do not bind to the grounds or beans and tend to settle unevenly in product packing bags resulting in inconsistent brews and experiences.

The present invention remedies the shortcomings of previous solutions by providing a process to bind electrolytes to the coffee beans or grounds that results in a brew with consistent profile.

### SUMMARY OF THE INVENTION

The invention comprises using a binding agent having nutritional properties to bind to and enhance ground or whole bean coffee (ground or whole bean coffee collectively referred to as “pre-brewed coffee”).

In one aspect, a process comprises binding and coating electrolytes to pre-brewed coffee. The resulting bound solution preserves the fresh pre-brewed coffee from oxidation, and the resulting brew acts to replenish the loss of electrolytes caused by the ingesting the brewed coffee.

In an additional aspect, the process comprises binding or adhering destabilized amino acid electrolyte salts to pre-brewed coffee. These destabilized amino acid electrolyte salts may include, but are not limited to potassium aspartate, sodium aspartate, or magnesium aspartate.

In this aspect the destabilized amino acid electrolyte salts act as a binding agent to bind the electrolyte properties to the pre-brewed coffee. The amino acid electrolyte salts are exposed to air and allowed to oxidize. The oxidation process results in a destabilized amino acid electrolyte salt having adhesive qualities. The amino salts being start in solid crystal form but change into a sticky adhesive liquid form when exposed to air. The resulting adhesive liquid form may then adhesively bind to the pre-brewed coffee or other powdered ingredients to be included in the brew. The coated pre-brewed coffee is preserved as the coating shields the pre-brewed coffee from exposure to the air, thereby reducing oxidation of the pre-brewed coffee.

In another aspect of the invention the amino salts are combined and mixed throughout the pre-brewed coffee prior to destabilization. The amino salts are then allowed to destabilize, oxidize, and bind to the premixed solution of pre-brewed coffee.

In yet another aspect, the binding agent is a component of a nutrient powder mixture.

In another aspect of the invention, the amino salts are powdered, evenly mixed with coffee grounds and disposed into a single serve coffee pod. In this aspect, upon puncturing the single serve pod, the amino salts are able to oxidize and destabilize thereby binding to and coating the coffee grounds.

In yet another aspect of the invention the amino salts are combined with other powdered ingredients such as sweetener, flavoring, other nutrients, and the pre-brewed coffee prior to destabilization.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a process flow chart representing an embodiment of the invention.

FIG. 2 is a process flow chart representing an embodiment of the invention.

FIG. 3 is a process flow chart representing an embodiment of the invention.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

The invention comprises using a binding agent having nutritional properties to bind to and enhance ground or whole bean coffee (ground or whole bean coffee collectively referred to as “pre-brewed coffee”).

On a high level, a process comprises binding and coating electrolytes to pre-brewed coffee. The resulting bound solution preserves the fresh pre-brewed coffee from oxidation, and the resulting brew acts to replenish the loss of electrolytes caused by the ingesting the brewed coffee.

In one aspect, the process comprises binding or adhering destabilized amino acid electrolyte salts to pre-brewed coffee. These destabilized amino acid electrolyte salts may include, but are not limited to potassium aspartate, sodium aspartate, or magnesium aspartate.

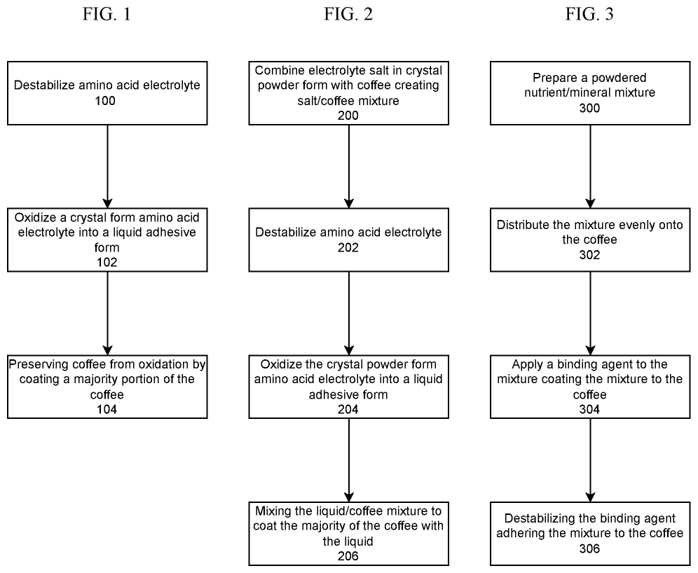

In this aspect as shown in FIG. 1, the destabilized amino acid electrolyte salts act as a binding agent to bind the electrolyte properties to the pre-brewed coffee. The amino acid electrolyte salts are destabilized through oxidation 100. The amino acid electrolyte salts are exposed to air and allowed to oxidize 102. The oxidation process results in a destabilized amino acid electrolyte salt having adhesive qualities. The amino salts being start in solid crystal form but change into a sticky adhesive liquid form when exposed to air. The resulting adhesive liquid form may then adhesively bind to the pre-brewed coffee or other powdered ingredients to be included in the brew. The coated pre-brewed coffee is preserved as the coating shields the pre-brewed coffee from exposure to the air, thereby reducing oxidation of the pre-brewed coffee 104.

In another aspect of the invention as detailed in FIG. 2, the amino salts are combined and mixed throughout the pre-brewed coffee prior to destabilization. The amino salts are then allowed to destabilize, oxidize, and bind to the premixed solution of pre-brewed coffee. In this aspect, the electrolyte salts are in crystal powder form, and combined with the pre-brewed coffee creating a salt/coffee mixture 200. The amino acid electrolyte is then destabilized through oxidation 202. The destabilized powder is transformed into a liquid adhesive 204. And the liquid adhesive is mixed and evenly distributed throughout the pre-brewed coffee 206.

In yet another aspect, as detailed in FIG. 3 the binding agent is a component of a nutrient powder mixture. In one example, powdered amino acid electrolyte salts are combined with other powdered nutrients or minerals including but not limited to sodium citrate, magnesium glycinate, or calcium chloride. In this example, the powdered amino acid electrolyte salts may make up about 30% to 50% of the mixture. The further below 30% of the mixture the binding agent gets, the less effective the binding agent becomes to coat the pre-brewed coffee. The further above 50% of the mixture the binding agent gets, the stickier binding agent and leads to clumping together of the other powders of the pre-brewed coffee.

In this example operation the amino salt is mixed or blended with the other powdered ingredients to ensure even distribution of compounds 300, 302. The mix/blending process must minimize exposure to air to avoid early oxidation of the amino salts. The pre-brewed coffee is disposed into a mixing/agitating device and the premixed amino salt compound is added 302. Upon adding the premixed amino acid compound, the new mixture is immediately mixed and agitated to ensure no clumping or uneven distribution of compound takes place. This mixing takes place in an open air environment or an environment allow oxidation of amino salts to begin the binding process 304. In some aspects, a humidity level of about 40% may help to further destabilize the amino acid salts. After no more powder or granules are visible, continued mixing or agitation for a brief period of time, 1-2 minutes may also help, but is not required to ensure adequate binding and distribution. After adequate mixing has taken place the mixture is bound to the pre-brewed coffee and the pre-brewed coffee is ready to be packaged or stored and sealed 306.

After the process is complete, in some examples, the electrolyte portion of the gross weight of the pre-brewed coffee is about 10% in the instance of using the contemplated mixture listed above wherein 3%-5% of finished product is the binding agents.

In other examples methyl cellulose or propylene glycol may be used as binding agents, in a similar fashion, but do not add the added benefit of electrolytes. In these examples, more moisture may have to be added for the binding agents to be effective as they do not liquefy like the destabilized amino salts.

In another aspect of the invention, the amino salts are powdered, evenly mixed with coffee grounds and disposed into a single serve coffee pod. In this aspect, upon puncturing the single serve pod, the amino salts are able to oxidize and destabilize thereby binding to and coating the coffee grounds.

In yet another aspect of the invention the amino salts are combined with other powdered ingredients such as sweetener, flavoring, other nutrients, and the pre-brewed coffee prior to destabilization. Upon destabilization, the adhesive liquid form coats and binds to all powdered ingredients. In resulting solution may then be bagged or placed in single served packaged solutions such as individual packets or pods.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

Those of ordinary skill in the art will understand and appreciate the aforementioned description of the invention has been made with reference to certain exemplary embodiments of the invention, which describe an electrolyte infused coffee and process. Those of skill in the art will understand that obvious variations in construction, material, dimensions or properties may be made without departing from the scope of the invention which is intended to be limited only by the claims appended hereto

1. A method of binding an electrolyte solution to ground or whole bean coffee comprising the steps of:
destabilizing amino acid electrolyte salt from a crystal form to a liquid adhesive form;
applying the liquid adhesive form of the destabilized amino acid electrolyte salt to the ground or whole bean coffee.

2. The method of claim 1 wherein the step of destabilizing the amino acid electrolyte salt from a crystal form to a liquid adhesive form comprises the step of oxidizing the amino acid electrolyte salt in an open air environment.

3. The method of any of claims 1-2 wherein the step applying the liquid adhesive form of the destabilized amino acid electrolyte salt to the ground or whole bean coffee further comprises the step of preserving the ground or whole bean coffee from oxidation by coating a majority portion of the ground or whole bean coffee.

4. The method of any of claims 1-3 wherein the amino acid electrolyte salt is selected from any one of the following: potassium aspartate, sodium aspartate, or magnesium aspartate.

5. The method of any of claims 1-4 wherein the step of applying destabilizing the amino acid electrolyte salt comprises oxidizing the amino acid electrolyte salt in an environment having a humidity level of about 40%.

6. The method of any of claims 1-5 wherein the step of applying the liquid adhesive for of the destabilized amino acid electrolyte alt comprises mixing or agitating the liquid adhesive and ground or whole bean coffee until powder or granules are no longer visible.

7. The method of any of claims 1-6 wherein the destabilized amino acid electrolyte salt is about 10% of the gross weight of the destabilized amino acid electrolyte salt and coffee mixture.

8. A method of binding an electrolyte solution to ground or whole bean coffee comprising the steps of:
combining at least one amino acid electrolyte salt in crystal powder form with ground or whole bean coffee into a salt coffee mixture;
destabilizing the amino acid electrolyte salt, transforming the amino acid electrolyte salt into and adhesive liquid form by oxidizing the amino acid salt with the salt coffee mixture; and
mixing the salt coffee mixture to coat the majority of the ground or whole bean coffee with the adhesive liquid.

9. The method of claim 8 wherein the salt coffee mixture is disposed into a single serve coffee pod and the amino acid electrolyte salt is destabilized upon puncturing the single serve coffee pod and exposing the salt coffee mixture to oxygen.

10. A method of binding nutrients or minerals to ground or whole bean coffee comprising the steps of:
preparing a powdered nutrient or mineral mixture; and
distributing the powdered nutrient or mineral mixture evenly into the ground or whole bean coffee; and
applying a binding agent binding the powdered nutrient or mineral mixture to the ground or whole bean coffee.

11. The method of claim 10 where the step of preparing a powdered nutrient or mineral mixture comprises the step of adding a powdered amino acid electrolyte salt in a low oxygen environment.

12. The method of any of claims 10-11 wherein the step of applying a binding agent comprises the steps of oxidizing the powdered amino acid electrolyte salt, transforming the powdered amino acid electrolyte salt into a liquid adhesive destabilized amino acid electrolyte salt and mixing the powdered nutrient or mineral mixture with the ground or whole bean coffee until it coats and adheres to the ground or whole bean coffee.

13. The method of any of claims 10-12 wherein the powdered nutrient or mineral mixture comprises at least one of a sweetener or flavoring.

14. The method of claim 10 wherein the binding agent is methyl cellulose or propylene glycol.
